(19) United States
(12) Patent Application Publication
(10) Pub. No.: US 2024/0270876 A1
(43) Pub. Date: Aug. 15, 2024

(54) ONE-POT PRODUCTION OF CELLULOSE NANOCRYSTALS

(71) Applicant: NANO-GREEN BIOREFINERIES INC., Saskatoon (CA)

(72) Inventor: Sean MCALPINE, Saskatoon (CA)

(21) Appl. No.: 18/569,567

(22) PCT Filed: Jun. 15, 2022
(86) PCT No.: PCT/CA2022/050952

§ 371 Date: Dec. 12, 2023

Related U.S. Application Data
(60) Provisional application No. 63/211,291, filed on Jun. 16, 2021.

(51) Int. Cl. C08B 15/02; C08B 1/08

(52) U.S. Cl. CPC C08B 15/02; C08B 1/08

(57) ABSTRACT

A method of producing cellulose nanocrystals from a purified cellulose includes a single stage and/or one-pot reaction of pretreating the cellulose with NaOH before oxidizing the cellulose with a hypohalite solution and a transition metal catalyst.

### FIELD OF THE INVENTION

The present invention relates to methods of producing cellulose nanocrystals using an oxidation reaction and a transition metal catalyst.

### BACKGROUND

Cellulose nanocrystals (CNC), also known as whiskers, nanowhiskers, crystalline nanocellulose or nanocrystalline cellulose, are conventionally produced using acid hydrolysis, in a similar manner to that of microcrystalline cellulose (MCC) production. Highly pure cellulose such as dissolving grade alpha cellulose or Kraft pulp is digested with a strong mineral acid (such as 64% sulfuric acid), followed by a physical size reduction. However, acid hydrolysis is expensive due to high capital and operating costs, relatively low yields. The use of corrosive mineral acids is problematic with respect to safety and environment. In addition, the tight control requirements of sulfuric acid concentration and temperature necessitate the use of dried pulp as the biomass source.

Physical properties of CNC are strongly influenced by the source material, the type of acid used in digest (hydrochloric or sulfuric), charge and dimensions. Several mechanical size reduction processes can be used following acid digestion, such as ultrasonic treatment, cryogenic crushing and grinding, and homogenization such as fluidization, which may also increase yield. CNC particles are generated with variable sizes reported in the literature—widths from 5 to 70 nm and lengths from 100 to about 1000 nm.

CNC may also be generated from MCC using strong mineral acid hydrolysis followed by separation by differential centrifugation, which results in a narrow size distribution of the CNC (Bai et al., 2009).

It is also known to produce crystalline cellulose using hydrogen peroxide chemistry which may involve modified Fenton or Haber Weiss reactions, involving a transition metal catalyst. However, such reactions may be lengthy and typically produce a mixture of microcrystalline cellulose with some nanosized crystals. The product has heterogenous morphology and size fractions, which requires further processing to produce substantially pure CNC, or other products with a narrow size distribution.

It is also known to produce crystalline cellulose using hypochlorite as an oxidant. High-quality cellulose, such as dissolving pulp, is converted to MCC in a first redox reaction, and then to CNC after a second redox reaction. This two-step process is enhanced by washing the intermediate MCC in an alkaline solution.

There is a need in the art for improved methods of producing cellulose nanocrystals.

### SUMMARY OF THE INVENTION

In one aspect, the present invention may comprise a method of producing substantially pure cellulose nanocrystals (CNC) from a purified cellulose, comprising the steps of:
(a) pretreating the purified cellulose at a pH of greater than about 9.0;
(b) oxidizing the cellulose with a hypohalite and a transition metal catalyst to degrade amorphous regions of the cellulose to produce cellulose nanocrystals; and
(b) recovering substantially pure cellulose nanocrystals.

In some embodiments, the pretreatment step comprises dispersing the cellulose in an aqueous slurry, and the hypohalite is added to the cellulose slurry following pretreatment. In some embodiments, the pretreatment pH of the slurry is greater than about 10.0, and preferably greater than about 11.0. Preferably, NaOH is added to the slurry, in an amount sufficient to reach the desired pH, which may be from about 2.0 mg/g of cellulose to about 20 mg/g of cellulose. In some embodiments, the dosage of NaOH is between about 6.0 mg/g to about 10.0 mg/g.

The pretreatment may continue for about 5 to about 60 minutes, at an elevated temperature, before the oxidation step which is initiated by adding hypohalite to the cellulose slurry. Addition of the hypohalite will increase the oxidation-reduction potential (ORP) to greater than about 300 mV, and preferably greater than about 400 mV. The oxidation reaction may then continue until the hypohalite is consumed, which results in a rapid drop in ORP, to below 100 mV.

A transition metal catalyst is added at any time prior to or with hypohalite addition. In some embodiments, the transition metal catalyst is added before or with the alkaline pretreatment.

In some embodiments, the hypohalite salt comprises an oxyanion containing a halogen in a +1 oxidation state, and may include sodium or calcium salts of hypochlorite, hypoiodite, or hypobromite. In preferred embodiments, the hypohalite comprises sodium hypochlorite.

Optionally, the CNC product may be washed in an alkaline solution, such as NaOH.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention.

FIG. 1 is a schematic representation of one method of the present invention.

FIG. 2 is a graph shown the pH and temperature of a single stage, one-pot process to produce substantially pure CNCs from a purified cellulose.

FIG. 3 is a graph showing ORP and temperature of a single stage, one-pot process to produce substantially pure CNCs from a purified cellulose.

### DETAILED DESCRIPTION OF PREFERRED EMBODIMENTS

The present invention relates to methods of producing crystalline cellulose from a purified cellulose. As used herein, “purified cellulose” includes any material which comprises a substantial proportion of cellulose, where non-cellulosic components such as lignin or hemicellulose have substantially been removed. Purified cellulose is prepared from lignocellulosic biomass, and comprises at least about 70%, preferably at least about 80%, and more preferably at least about 90% cellulose. Purified cellulose may include alpha-cellulose, dissolving grade pulp, Kraft pulp, or other pulps, such as paper-making pulp or recycled pulp. The pulp may be produced by any known method, including mechanical, thermomechanical, chemical, and chemi-thermomechanical processes. Purified cellulose may be produced from any suitable lignocellulosic biomass, such as wood, hemp or cereal straw, and may be bleached or unbleached. The purified cellulose may be used in dried form, hydrated, or as an aqueous suspension. As used herein, “purified cellulose” does not include crystalline cellulose, such as microcrystalline cellulose (MCC) or other forms of cellulose where amorphous regions of cellulose have been substantially degraded or removed.

Cellulose is a polysaccharide comprising D-glucose units in linear and branched chains. The linear chains are ordered in a parallel structure in crystalline regions, however, there are para-crystalline and amorphous regions which lack such order and structure. The amorphous regions are more susceptible to acid hydrolysis, and thus crystalline cellulose is conventionally produced by acid hydrolysis to digest and remove the amorphous regions. Crystalline cellulose comprises cellulose where at least a portion of the amorphous cellulose present in the cellulosic material has been removed, leaving a greater proportion of the cellulose in crystalline form.

In some embodiments, crystalline cellulose is cellulose having a crystallinity index (CI) which is at least 10%, 20%, 25% or 30% greater than the CI of the purified cellulose prior to the reaction, wherein the CI is measured by any suitable method, provided that the same method is used in each case. Crystalline cellulose has a CI of at least about 50%, and preferably greater than about 60, 70, 80, 90, 95 or 98%, depending on the method used to measure CI and the nature of the material. Crystallinity index may be measured by X-ray diffraction using a peak height method, a peak deconvolution method, an amorphous subtraction method, or an NMR method. (Park et al. Cellulose crystallinity index: measurement techniques and their impact on interpreting cellulase performance, Biotechnol Biofuels. 2010; 3: 10).

CI measurements using a peak height method typically result in a CI higher than with other methods. Table 1 below shows the crystallinity index of several known cellulosic materials and commercial MCC products, using the various methods described above.

| | XRD method | | | |
|---|---|---|---|---|
| | | | Amor- | |
| | | Peak | phous | NMR method |
| | Peak | deconvo- | sub- | C4 peak |
| Cellulose tested | height | lution | traction | separation |
| BMCC | 95.2 | 73.1 | 82.4 | 73.8 |
| Avicel PH-101* | 91.7 = 1.5 | 60.6 = 1.0 | 77.7 = 1.9 | 56.7 = 2.2 |
| SigmaCell 50 | 91.2 | 61.3 | 79.4 | 56.1 |
| SigmaCell 20 | 84.8 | 64.2 | 67.0 | 52.6 |
| JT Baker cellulose | 85.5 | 61.5 | 69.1 | 49.1 |
| Fluka cellulose | 82.9 | 52.9 | 61.6 | 45.6 |
| SolkaFloc cellulose | 78.3 | 56.8 | 57.2 | 43.9 |
| Sigma α-cellulose | 78.0 | 55.9 | 54.4 | 41.5 |

BMCC, bacterial microcrystalline cellulose.
Values are means.

Crystalline cellulose may comprise both microcrystalline cellulose (MCC) or CNC, or a mixture comprising both. As used herein, MCC comprises crystalline cellulose particles having at least one dimension greater than about 1 micron but less than about 1 mm, and usually less than about 500 microns. MCC particles may be elongated and have a diameter less than 1 micron. The production of MCC and CNC using two stage, multipot redox chemistry is described in U.S. Patent Publication US20190040158A1, the entire contents of which are incorporated herein by reference.

CNCs are particles comprising crystalline cellulose where all relevant dimensions are less than about 1 micron. CNC particles are typically long, high aspect crystals, having a diameter less than about 50 nm, and a length greater than about 50 nm and less than about 500 nm. In preferred embodiments, CNC particles have an average length of about 100 nm to about 400 nm, more preferably between about 100 to about 200 nm, and an average diameter of about 10 nm. CNC particles typically have a much higher aspect ratio than MCC, and may be in the range of about 10 to about 70.

In one aspect, the invention comprises a method of processing a purified cellulose using a hypohalite and a transition metal catalyst to produce substantially pure CNC. As used herein, “substantially pure CNC” means that less than 50%, 40%, 30%, 20%, 10% or 5% (weight) of the resulting crystalline cellulose is not CNC. One method of determining homogeneity of CNC is to determine particle size distribution. Preferably, substantially pure CNC demonstrates a single peak below about 1 micron, with few particles greater than 1 micron in size. For example, the recovered substantially pure CNC may have a single peak of size distribution, where the average particle size is less than about 400 nm, 300 nm, 200 nm, or 100 nm. Particle size and distribution may be measured by any known technique, such as dynamic light scattering or quasi-elastic light scattering.

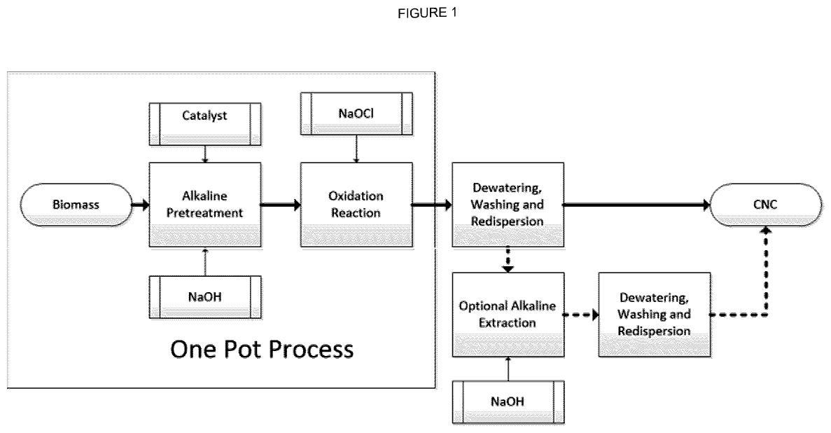

In some embodiments, the invention comprises steps to generate substantially pure CNC comprising the method shown schematically in FIG. 1. The primary steps of the process comprise pretreating a purified cellulose at an elevated pH, preferably with NaOH, followed by a oxidation by a hypohalite in a redox reaction. This redox reaction is where the cellulose is oxidized while the hypohalite is reduced. The process produces CNC in a single redox reaction stage.

In some embodiments, the process may comprise a “one-pot” method, where the reactants are added to a single reactor, and the desired product may be recovered from the single reactor.

A transition metal catalyst is added with hypohalite addition, or at any time prior to the redox reaction. In some embodiments, the transition metal catalyst is added before or during the alkaline pretreatment.

The purified cellulose starting material is preferably finely divided and may be suspended in an aqueous slurry, which may comprise about 1% to 15% (w/v) of dry weight of purified cellulose, preferably between about 2% to about 10%. The slurry may then be agitated until well-dispersed and the cellulose is substantially hydrated.

The alkaline pretreatment step occurs by raising the pH to greater than about 9.0, preferably greater than 10.0, and more preferably greater than about 11.0. Preferably, NaOH is added to the slurry, in an amount sufficient to reach the desired pH, which may be from about 2.0 mg/g of cellulose to about 20 mg/g of cellulose. In some embodiments, the dosage of NaOH is between about 6.0 mg/g to about 10.0 mg/g.

The pretreatment may continue for about 5 to about 60 minutes with heating, such as to above about 40° C., preferably above about 50° C., and more preferably to above about 60° C. In some embodiments, the alkaline pretreatment is carried out at about 75° C. The pH may gradually drop as the mixture is heated, but should remain above 10.0.

The oxidation step is initiated by adding hypohalite to the alkaline cellulose slurry. It is not necessary to wash the pretreated cellulose, the hypohalite may be added directly to the alkaline slurry. Addition of the hypohalite will increase the oxidation-reduction potential (ORP) to greater than about 300 mV, preferably greater than about 400 mV, and more preferably to greater than about 500 mV. In some embodiments, the initial ORP may be between about +500 to about +1000 mV. The mixture may continue to be heated, and the temperature may range from about 40° to about 95° C. It is not desirable to exceed 100° C., and the reaction proceeds slower at lower temperatures. Therefore, in some embodiments, the temperature may be between about 50° and 95° C., and preferably between about 65° C. to about 85° C.

In aqueous solutions, oxidation-reduction potential (ORP) is a measure of the tendency of the solution to either gain or lose electrons when it is subject to change by introduction of a new species. A solution with a higher ORP than the new species will have a tendency to gain electrons from the new species (i.e. to be reduced by oxidizing the new species) and a solution with a lower (more negative) reduction potential will have a tendency to lose electrons to the new species (i.e. to be oxidized by reducing the new species). ORP values of aqueous solutions are determined by measuring the potential difference between an inert sensing electrode in contact with the solution and a stable reference electrode connected to the solution by a salt bridge.

The length of the reaction will depend, at least in part, on the reaction rate and the original amount of the hypohalite. The ORP may rise as amorphous cellulose is degraded, until a point where the ORP will rapidly decrease when the hypohalite has been consumed. The ORP will drop rapidly to below about 100 mV, or about or below 0.0.

The amount of hypohalite may be adjusted to the amount of purified cellulose and/or the purity of the purified cellulose, and may be in the range of 5 mol chlorine per kg of purified cellulose to about 20 mol/kg (dry weight). In some preferred embodiments, the amount of hypohalite is between about 10 to about 16 mol/kg. Once the cellulose has been fully oxidized, excess hypohalite will continue to oxidize acids in solution, resulting in the production of carbon dioxide and water. Excess hypohalite will not detrimentally affect the reaction, but may reduce yield of the desired CNC product.

In some preferred embodiments, the hypohalite comprises sodium hypochlorite, which is commercially available in trade concentrations ranging from about 3% to about 20% (w:v). A trade concentration of 8% has a specific gravity of about 1.11, about 7.2% available chlorine, and 7.6% (w:w) NaOCl. A trade concentration of 12% has a specific gravity of about 1.17, about 10.4% available chlorine, and comprises about 10.9% (w:w) NaOCl.

Chlorine is soluble in water to about 7000 ppm at 20° C., and reacts with water forming hypochlorous acid (HOCl). In alkali solutions, hypochlorous acid dissociates, forming hypochlorite (OCl−). Chlorine, hypochlorous acid and hypochlorite exist together in equilibrium, which equilibrium is pH sensitive.

In one embodiment, the transition metal catalyst may comprise any suitable transition metal, such as iron, copper, manganese, molybdenum, rhodium, zinc or cobalt, and may be added at any point in the process. For example, the catalyst may be added at the start, during or after the pretreatment step, or before or during the oxidation step. The catalyst may be provided as a salt dissolved in solution, or may be provided on an insoluble support. The transition metal catalyst may comprise ferric (Fe³⁺), cupric (Cu²⁺), manganous (Mn²⁺), or cobalt (Co²⁺) ions, such as ferric sulphate (Fe₂(SO₄)₃), cupric sulphate (CuSO₄), or manganous sulphate (Mn₂SO₄). The catalyst may be added to achieve a minimum concentration of about 0.01 mM, and preferably has a concentration between about 0.045 mM to 0.67 mM. The ratio of transition metal ion to purified cellulose may be in the range of about 0.1 mg/g to about 5 mg/g, and preferably between about 0.2 mg/g to about 1.0 mg/g.

In some embodiments, in the redox reaction phase, ORP remains the same or increases slightly, while pH slowly decreases. In one embodiment, the endpoint of the reaction is marked by a sudden and large drop in ORP and a drop in pH below about 7.0, and preferably between about 4.0 and 6.0.

The resulting product is substantially pure CNC, preferably having a single peak of size distribution, where the average particle size is less than about 300 nm, 200 nm, or 100 nm. The substantially pure CNC may be washed and resuspended in water, preferably reverse osmosis (RO) water, and optionally may undergo physical treatment, such as mechanical agitation or ultrasound treatment, to deaggregate the particles.

Optionally, the substantially pure CNC product may be washed in an alkaline solution, such as NaOH. In some embodiments, this alkaline wash may be heated, for example between about 30° and 90° C., and held for about 5 minutes to 1 hour. The initial pH may be greater than about 10, 11 or 12, and will lower slightly as the wash proceeds. The CNC product may then be recovered, for example, by filtration.

The quality of substantially pure CNC product may be assessed on the following factors. Preferred embodiments of the resulting product will have higher quality characteristics.

| Measurement | Higher Quality | Lesser Quality |
|---|---|---|
| Cake on filter | Feels either rubbery or | Feels soft or fibrous |
| paper | greasy | |
| Microscope | Very small visible particles. | Visible fibres several |
| image 10 X | No particles after sonication | microns in length |
| Visible appear- | Clear or almost clear. | Opaque gel, white or |
| ance of gel or | Evidence of Rayleigh | off white. Remains |
| suspension | scattering. Sample goes | opaque after ultra- |
| | clear with ultrasound | sound treatment |
| Size by DLS* | One size peak at around | Two size peaks. One |
| | 100-200 nm. Zₐᵥₑ | at 800 nm to 1,000 nm. |
| | 100-200 nm | Zₐᵥₑ > 300 nm |
| Zeta Potential | Below −30 mV | Higher than - 30 mV in |
| | | association with settling |
| | | particles |

Zeta potential is a measurement of electrical potential amongst colloidal particles and their interaction with the dispersing media. It is used as an indication of the stability of a colloidal dispersion. Low values (−30 mV to +30 mV) suggest the particles may coagulate and/or settle. High absolute values, (less than −30 mV or greater than +30 mV), indicate good electrical stability of the colloid.

Other measurements which may be made on the product include measurement of amount of carboxyl content on the surface of the CNC, by a conductimetric titration with hydrochloric acid and sodium hydroxide. Units are in mmol/g. The carboxyl content and conductivity may provide an alternate measure for product purity.

Thixotropy or non-Newtonian behavour is a property of high quality CNC suspensions with uniform size distribution. Preferred embodiments will show thixotropic behaviour, indicating aspect ratios in the range of at least about 30 to 50.

Without restriction to a theory, it is believed that the surprising result of obtaining substantially pure CNC in a single stage, one-pot redox reaction is the alkaline pretreatment before the oxidant is added. The pretreatment step at an elevated pH, before addition of any oxidant, is required. The purified cellulose need not be washed after pretreatment, the oxidant may be added directly to the pretreated cellulose.

Examples—The following examples are intended to illustrate aspects of the claimed invention, but not be limiting in any manner, unless explicitly recited as a limitation.

### Example 1—Exemplary Method of Production

1. Put 10 g of pulp in the 600 mL beaker and add about 450 ml of water. Use the mechanical stirrer to fully disperse the pulp.
2. Add 1 mL of catalyst (0.0537 M).
3. Put the beaker on the hot plate and stir it magnetically. Put the pH, temperature and ORP probes in the beaker and start the data logger.
4. Add 4 mL of 2% NaOH (0.510 M).
5. Turn on the heater and set the temperature to 75° C.
6. When the temperature reaches 75° C., add 110 mL of 8% NaOCl (11.0 g or 1.1 g per g of pulp). This is the equivalent to 0.148 mol of chlorine, or 14.8 mol/kg of pulp)
7. Monitor the pH and ORP. The reaction is complete with a rapid decrease in ORP.
8. Dewater the mix with the 5 μm filter paper. When the free water is removed, add 100 mL of RO water.
9. Resuspend the cake from the filter in RO water. 200 mL total volume.
10. Treat the mixture with 30 seconds of ultrasound treatment (Heilscher UIP1000hd, 100% amplitude) to break up individual particles.
11. Optional—add 0.5 mL of 50% NaOH to the mix and heat to 75° C. for 1 hour. Repeat steps 8, 9 and 10.
   This standard reaction has the following conditions:

| Parameter | Description |
|---|---|
| Starting biomass | Sappi A86563 - Viscose Grade Dissolving |
| | Pulp (wood source Aspen and Maple) |
| Pulp mass | 9.46 g |
| Catalyst Added | 1 mL of 0.0537M solution |
| Sodium hypochlorite | 1.11 g of pure hypochlorite per g of biomass. |
| added | |
| Sodium hydroxide | 4 mL of 2% NaOH |
| added | |
| Reaction Temperature | 20° C., heated to 75° C. before |
| | hypochlorite is added. |
| Continuous tests | Temperature, pH and oxidation reduction |
| | potential (ORP) |
| Post stage treatment | Buchner filtration with 0.5 μm pore size |
| | cellulose filter with 100 mL |
| | RO water added after free water is removed |
| Final sample | Solid cake is dispersed in 200 mL reverse |
| preparation | osmosis water. Sample is then treated with 30 |
| | seconds ultrasound to deaggregate particles |
| | before testing |
| Product tests | Yield, particle size by DLS (Malvern |
| | Zetasizer ™ Nano Z) |

Under these conditions, the reaction had a product yield of 61.9% and average particle size of 107.7 nm (sd 2.75 nm).

### Example 2—Reaction Progress

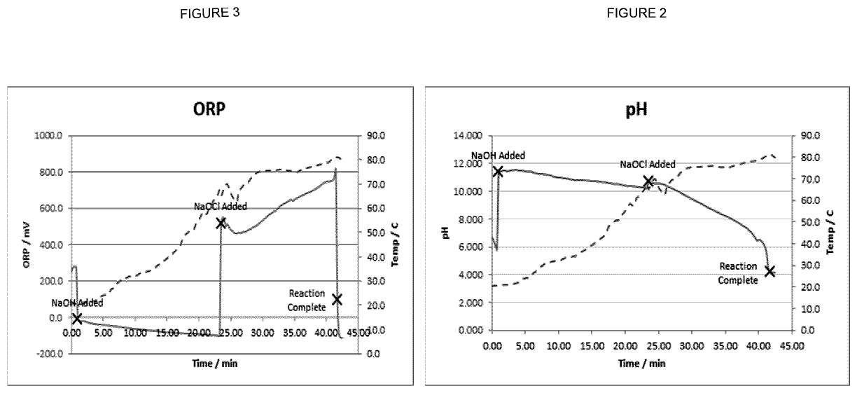

FIGS. 2 and 3 are graphs which show the pH, ORP and temperature of the reaction described in Example 1 above.

The graph is labeled at the points of NaOH and hypochlorite were added. The addition of NaOH increases the pH to about 11.6. As the mixture temperature increases, the pH drops to about 10.5. When hypochlorite is added, ORP goes from about −100 mV up to about 550 mV. As the reaction progresses, pH decreases and ORP increases. When the reaction is complete, the ORP rapidly switches from highly positive to slightly negative. Reaction time is measured from the time from hypochlorite addition to the end of the reaction.

### Example 3—Different Cellulose Sources

The following table is a description of the different types of pulp used to produce CNCs.

| Cellulose | Description |
|---|---|
| Sappi A86563 - | Viscose Grade Dissolving Pulp, wood |
| | source Aspen and Maple |
| Cosmo 95-70 | Acetate Grade Dissolving Pulp, wood |
| | source Western Hemlock |
| International Paper | Northern Bleached Softwood Kraft Pulp, |
| Grande Prairie | wood source Pine and Spruce |
| Softwood (GP) | |
| Alberta Pacific | Northern Bleached Hardwood Kraft Pulp, |
| Hardwood (AlPac) | wood source Aspen |
| PureHemp Pulp | Papermaking Pulp, biomass source Hemp Straw |
| Columbia Pulp | Papermaking Wetlap Pulp, biomass source |
| | Wheat Straw |

The following table has the results of the tests of different biomass sources.

| | Hypochlorite | Reaction | | Particle | |
|---|---|---|---|---|---|
| | Dosage | Time | | Size/nm | |
| Biomass | (g/g dry pulp) | (min) | Yield | (std dev) | |
| Sappi | 1.11 | 19.00 | 61.9% | 107.7 | (2.75) |
| Cosmo 95-70 | 1.303 | 15.00 | 54.9% | 201.4 | (2.95) |
| AlPac | 1.650 | 14.50 | 37.8% | 169.4 | (1.90) |
| GP | 1.650 | 16.50 | 36.5% | 182.2 | (7.20) |
| PureHemp | 1.690 | 11.50 | 48.2% | 101.7 | (1.38) |
| Columbia | 1.690 | 10.50 | 47.4% | 390.8 | (79.83) |

These results shows that the process works with a variety of purified cellulose sources. The difference in yield comes mainly from the differences in the cellulose content of the starting material. Dissolving pulp typically has higher cellulose content than kraft and other papermaking pulps. The result of this is dissolving pulps tend to have higher yield and require less hypochlorite to convert the biomass into CNC.

### Example 4—Effect of Temperature

The following table shows the effect of changing temperature on reaction time, yield and particle size. The other parameters are as described in Example 1 above.

| Temperature | Reaction Time | | Particle Size/nm |
|---|---|---|---|
| (° C.) | (min) | Yield | (std dev) |
| 45 | 368.00 | 59.2% | 145.2 (2.30) |
| 60 | 70.75 | 60.4% | 122.2 (0.50) |
| 75 | 19.00 | 61.9% | 107.7 (2.75) |
| 85 | 8.25 | 56.4% | 148.3 (3.08) |

The reaction time is most affected by temperature. Lower temperatures resulted in longer reaction times. Yield and particle size are only slightly affected.

### Example 5—Effect of NaOH Dosage

The amount of NaOH added at the start of the process was varied. All other parameters were held constant. The following table shows the effects of this change.

| NaOH/mg/g | Reaction | | Particle Size/nm |
|---|---|---|---|
| pulp | Time/min | Yield | (std dev) |
| 4.23 | 16.75 | 58.8% | 120.8 (0.66) |
| 8.46 | 19.00 | 61.9% | 107.7 (2.75) |
| 16.91 | 20.75 | 55.7% | 183.3 (7.77) |

The dosage of NaOH affected the reaction time only slightly. The higher dosage appears to have yielded a slightly less efficient reaction due to lower yield and higher particle size.

### Example 6—Effect of Catalyst Dosage

The amount of CuSO₄ catalyst added at the start of the process was varied. All other parameters were held constant. The following table shows the effects of this change.

| Catalyst | Reaction Time | | Particle Size |
|---|---|---|---|
| (mmol/g pulp) | (min) | Yield | (nm (std dev) |
| 0.003 | 24.00 | 60.9% | 128.3 (2.97) |
| 0.006 | 19.00 | 61.9% | 107.7 (2.75) |
| 0.011 | 11.00 | 51.3% | 141.8 (3.87) |

Increased catalyst addition shortened reaction time, but with decreased yield and larger average particle size above about 0.006 mmol/g.

### Example 7—Catalyst Type

Five different transition metals were used, each as a sulfate salt. Other testing has demonstrated that the salt chosen does not have a substantial effect. They were all added at the same dosage of 0.006 mmol/g of pulp. The following table shows the effects of each catalyst.

| Catalyst | Reaction Time/min | Yield | Particle Size/nm (std dev) | |
|---|---|---|---|---|
| Copper | 19.00 | 61.9% | 107.7 | (2.75) |
| Cobalt | 5.00 | 28.2% | 93.88 | (0.78) |
| Manganese | 23.75 | 67.9% | 139.3 | (3.43) |
| Iron | 26.50 | 67.0% | 138.7 | (3.00) |
| Zinc | 26.50 | 65.7% | 142.4 | (4.39) |

All of the catalysts performed similarly with the exception of cobalt. This catalyst increased the speed of the reaction and, without restriction to a theory, it is believed made the reaction less selective for amorphous degradation, resulting in a reduced yield of crystalline cellulose, but the product had a higher purity. Copper, manganese, iron and zinc act in essentially the same way.

### Example 8—Optional Post Alkaline Wash

A batch of substantially pure CNC product (11.5 kg dry mass) is dispersed in a stainless steel, jacketed reactor to a volume of 750 L of water. 1,000 mL of 50% sodium hydroxide is added to the suspension and it is heated to 75° C. and held at that temperature for 30 minutes. The initial pH is 11.2 and the ending pH is 10.0. The colour of the suspension turns from white to dark brown. The mixture is then pumped to a membrane diafiltration system. The diafiltration system washes the CNC product with reverse osmosis water until it reaches pH and conductivity equilibrium.

### Definitions and Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”,

“at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only: they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

1. A method of producing substantially pure crystalline nanocellulose (CNC) from a purified cellulose, comprising the steps of:
a. pretreating the cellulose at a pH of greater than about 9.0;
b. oxidizing the cellulose with a hypohalite and a transition metal salt catalyst to degrade amorphous regions of the cellulose to produce substantially pure CNC:
c. optionally deaggregating the CNC: and
d. recovering the substantially pure CNC.

2. The method of claim 1, wherein the purified cellulose comprises a paper-making pulp, such as a wood, hemp or cereal grain straw pulp.

3. The method of claim 1, wherein pretreatment step comprises dispersing the cellulose in an aqueous slurry, and the hypohalite is directly added to the aqueous slurry following pretreatment.

4. The method of claim 1 wherein the hypohalite comprises an oxyanion containing a halogen in a +1 oxidation state, such as sodium or calcium salts of hypochlorite, hypoiodite, or hypobromite.

5. The method of claim 4 wherein the hypohalite comprises sodium hypochlorite.

6. The method of claim 1, wherein the pretreatment pH of the slurry is greater than about 10.0, preferably greater than about 11.0.

7. The method of claim 6, wherein the pretreatment step comprises the addition of NaOH in an amount sufficient to reach the desired pH.

8. The method of claim 7 wherein the NaOH is added in an amount from about 2.0 mg/g of cellulose to about 20 mg/g of cellulose, such as between about 6.0 mg/g to about 10.0 mg/g.

9. The method of claim 1, wherein the pretreatment step is at a temperature between about 30° to about 95°.

10. The method of claim 1 wherein the oxidation step is at a temperature between about 30° to about 95°.

11. The method of claim 1 wherein the hypohalite is added at a concentration of about 5 mol/kg of purified cellulose to about 20 mol/kg (dry weight), preferably between about 10 to about 16 mol/kg.

12. The method of claim 1, wherein the catalyst comprises copper, manganese, iron, zinc or cobalt, such as a Cu, Mn, Fe, Zi or Co sulphate salt.

13. The method of claim 1, wherein the concentration of catalyst in the aqueous slurry is between 0.1 mg/g to 5 mg/g, preferably between about 0.2 mg/g to about 1.0 mg/g.

14. The method of claim 1 wherein the recovered substantially pure CNC has a single peak of size distribution, where the average particle size of the recovered substantially pure CNC is less than about 400 nm, 300 nm, 200 nm, or 100 nm.

15. A method of producing substantially pure CNC from a purified cellulose, in a single stage and/or one-pot reaction, wherein the purified cellulose is pretreated with an alkali and then oxidized with a hypohalite and a transition metal catalyst.

16. The method of claim 15 wherein:
a. the hypohalite comprises an oxyanion containing a halogen in a +1 oxidation state, such as sodium or calcium salts of hypochlorite, hypoiodite, or hypobromite: and/or
b. the pretreatment pH is greater than 9.0, 10.0 or 11.0.

17. Substantially pure cellulose nanocrystals (CNCs) produced in a single stage and/or one-pot reaction, wherein the purified cellulose is pretreated with an alkali and then oxidized with a hypohalite and a transition metal catalyst.

18. The CNCs of claim 17 wherein the average particle size of the CNCs is less than about 400 nm, 300 nm, 200 nm, or 100 nm
